(19) United States
(12) Patent Application Publication
(10) Pub. No.: US 2017/0326907 A1
(43) Pub. Date: Nov. 16, 2017

(54) ELECTROLUMINESCENT TRANSFER LAMINATE AND ELECTROLUMINESCENT TRANSFER UNIT OBTAINED THEREFROM

(71) Applicant: Chiung-Ling CHEN, Taichung City (TW)

(72) Inventor: Chiung-Ling CHEN, Taichung City (TW)

(21) Appl. No.: 15/587,300

(22) Filed: May 4, 2017

(30) Foreign Application Priority Data
May 10, 2016 (TW) 105114370

(51) Int. Cl. B44C 1/175

(52) U.S. Cl. CPC B44C 1/1752

(57) ABSTRACT

An electroluminescent transfer laminate includes a flexible substrate unit including a water-soluble layer, and an electroluminescent transferable unit. The electroluminescent transferable unit is formed on the water-soluble layer and includes a first light-transmittable protecting layer, a first electrode-forming layer including a conductive looped frame portion and a first electrode protruding from the conductive looped frame portion, a light-transmittable conductive polymeric layer, an electroluminescent layer, a second electrode-forming layer including a main portion and a second electrode protruding from the main portion, a second protecting layer, and an adhesive layer adapted to be adhered to a target object.

### CROSS-REFERENCE TO RELATED APPLICATION

This application claims priority of Taiwanese Invention Patent Application No. 105114370, filed on May 10, 2016.

### FIELD

The disclosure relates to a transfer laminate, and more particularly to an electroluminescent transfer laminate and an electroluminescent transfer unit obtained from the same.

### BACKGROUND

Conventional transfer laminates are adapted for transferring a pattern to an object so that the target object with the transfer pattern can exhibit various appearances. For example, water transfer laminates are easy to use and thus are widely applied in the DIY decoration field. Due to expansion and variations in the application field of the transfer laminates, fluorescent water transfer laminates have been developed in addition to monochromatic or color transfer laminates.

The conventional fluorescent transfer laminates are widely used for showing a predetermined pattern at night as a warning sign or for attracting attention. For example, the fluorescent water transfer laminate may be transferred to a bicycle or a bulletin board to serve as decoration or a night-time warning sign.

However, the fluorescent patterns obtained from the conventional fluorescent transfer laminates have limited illumination time and lifetime. There is much room for improvement in regard to transfer laminates with illumination patterns.

### SUMMARY

Therefore, an object of the disclosure is to provide an electroluminescent transfer laminate that can alleviate at least one of the drawbacks of the prior art.

According to one aspect of the disclosure, an electroluminescent transfer laminate includes a flexible substrate unit, and an electroluminescent transferable unit.

The flexible substrate includes a water-soluble layer.

The electroluminescent transferable unit is formed on the water-soluble layer, and includes a first protecting layer, a first electrode-forming layer, a light-transmittable conductive polymeric layer, an electroluminescent layer, a second electrode-forming layer, a second protecting layer, and an adhesive layer.

The first protecting layer is light-transmittable.

The first electrode-forming layer includes a conductive looped frame portion that is formed on the first protecting layer, and a first electrode that protrudes from the conductive looped frame portion outwardly of the first protecting layer.

The light-transmittable conductive polymeric layer is formed on the conductive looped frame portion and a portion of the first protecting layer that is exposed from the conductive looped frame portion.

The electroluminescent layer is formed on the light-transmittable conductive polymeric layer.

The second electrode-forming layer includes a main portion that is formed on the electroluminescent layer, and a second electrode that protrudes from the main portion outwardly of the first protecting layer and separated from the first electrode.

The second protecting layer is formed on the second electrode-forming layer.

The adhesive layer is formed on the second protecting layer, and is adapted to be adhered to a surface of a target object.

According to another aspect of the disclosure, an electroluminescent transfer unit is obtained from the abovementioned electroluminescent transfer laminate through solvent transfer techniques on the target object, and includes the first protecting layer, the first electrode-forming layer, the light-transmittable conductive polymeric layer, the electroluminescent layer, the second electrode-forming layer, the second protecting layer, and the adhesive layer of the abovementioned electroluminescent transferable unit.

### BRIEF DESCRIPTION OF THE DRAWINGS

Other features and advantages of the disclosure will become apparent in the following detailed description of the embodiment with reference to the accompanying drawings, of which:

FIG. 1 is an exploded perspective view illustrating an embodiment of an electroluminescent transfer laminate according to the disclosure;

FIG. 2 is a fragmentary schematic view illustrating consecutive steps of a transfer process of an electroluminescent transferable unit of the embodiment to a surface of a target object;

FIG. 3 is a photograph illustrating the electroluminescent transfer unit of the disclosure transferred to the target object in an electrically disconnected state;

FIG. 4 is a photograph illustrating the electroluminescent transfer unit of the disclosure transferred to the target object in an electrically connected state;

FIG. 5 is a schematic view illustrating a light shielding pattern layer applicable to the first embodiment; and;

FIG. 6 is a fragmentary schematic view illustrating another configuration of the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

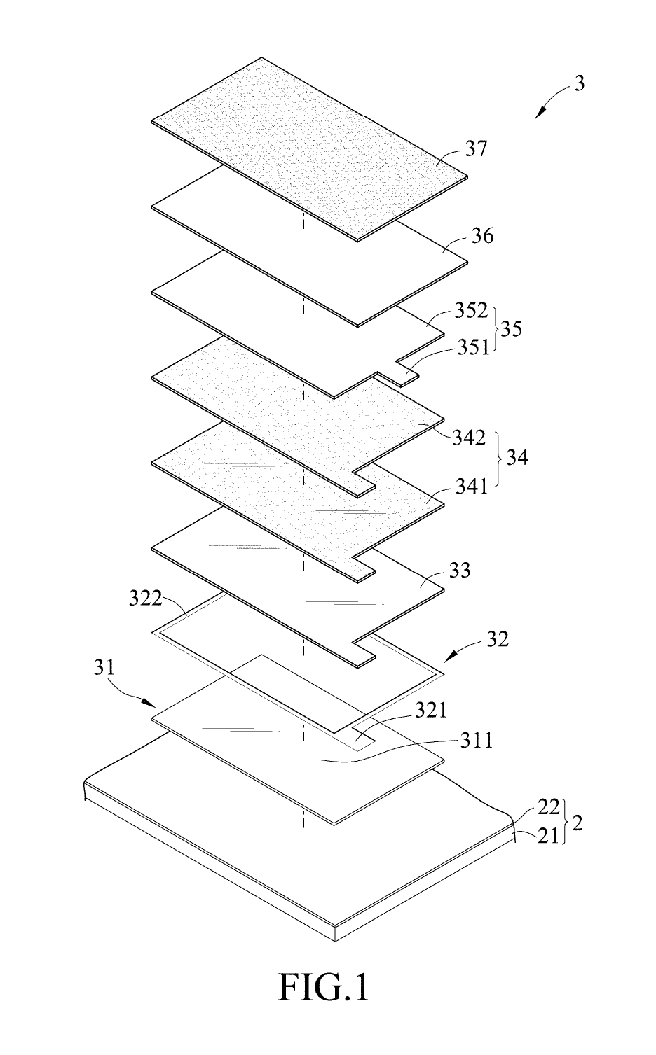

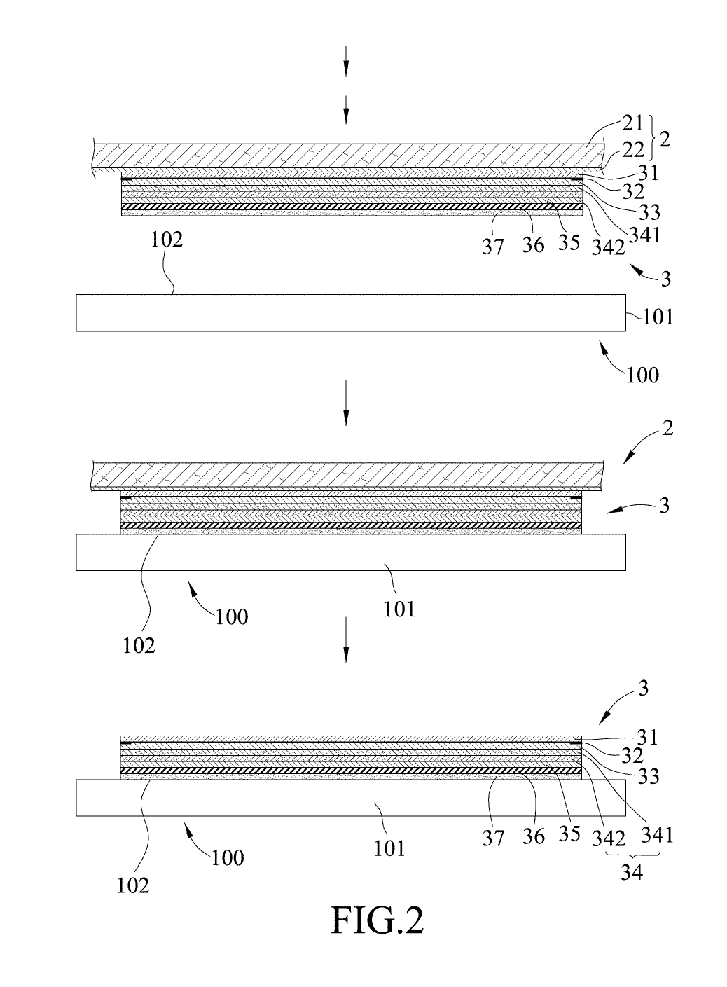

Referring to FIGS. 1 and 2, the embodiment of an electroluminescent transfer laminate according to the disclosure is applied to a surface 101 of a target object 100 using solvent transfer techniques. The target object 100 is connected to a power supply (not shown).

Examples of the target object 100 include a bulletin board, a helmet, firefighting equipment, a vehicle (e.g. a bicycle or an electric car), or vehicle components, etc. The power supply may be, but not limited to, a chemical battery (e.g. a nickel-metal hydride battery or an alkaline battery), a solar cell, and so on. The power supply connected to the target object 100 may be a built-in or plug-in type.

The embodiment of the electroluminescent transfer laminate according to the disclosure includes a flexible substrate unit 2 and an electroluminescent transferable unit 3.

The flexible substrate unit 2 includes a substrate 21 and a water-soluble layer 22 that is disposed on the substrate 21. The substrate 21 may be transparent or opaque and in the form of a piece of paper or a thin film, such as polyethylene terephthalate (PET), polyethylene (PE), or polyurethane (PU), etc. The water-soluble layer 22 is made from a water-soluble polymeric material, such as Arabic gum, xanthan gum, gelatin, polyvinyl alcohol, and so on.

The electroluminescent transferable unit 3 is formed on the water-soluble layer 22 and includes a first protecting layer 31, a first electrode-forming layer 32, a light-transmittable conductive polymeric layer 33, an electroluminescent layer 34, a second electrode-forming layer 35, a second protecting layer 36, and an adhesive layer 37. In the embodiment, the electroluminescent transferable unit 3 may be manufactured using screen printing techniques. Since the screen printing techniques per se are not the essential features of the disclosure, and are well known to those skilled in the art, further details thereof are not provided herein for the sake of brevity.

The first protecting layer 31 is light transmittable and formed on the water-soluble layer 22. The first protecting layer 31 may be made from an insulating and light-transmittable polymeric material, such as epoxy resin, etc., and serves as a protection layer, i.e., clear varnish. In one form, the first protecting layer 31 is rectangular in shape.

The first electrode-forming layer 32 includes a conductive loop frame portion 322 that is formed on the first protecting layer 31, and a first electrode 321 that protrudes from the conductive looped frame portion 322 outwardly of the first protecting layer 31. The first electrode-forming layer 32 is made from an electrically conductive material selected from silver, aluminum, copper, conductive carbon materials, and so on.

The light-transmittable conductive polymeric layer 33 is formed on the conductive looped frame portion 322 and a portion 311 of the first protecting layer 31 that is exposed from the conductive looped frame portion 322.

When the electroluminescent transfer laminate is required to be adapted to be manufactured using the screen printing techniques and attached to the surface 101 of the target object 100 with a curved shape, the constituent layers of the electroluminescent transferable unit 3, i.e., the first and second protecting layers 31, 36, the first and second electrode-forming layers 32, 35, the light-transmittable conductive polymeric layer 33, the electroluminescent layer 34, and the adhesive layer 37, are required to have properties of flexibility and film-forming ability. Thus, the light-transmittable conductive polymeric layer 33 may include a conductive polymer and an additional polymer with the film-forming ability. The conventional transparent conductive layer, which is a light-transmittable conductive non-flexible layer, such as an ITO film, is not applicable. More specifically, the light-transmittable conductive polymeric layer 33 may include a conductive polymer and a light-transmittable thermoplastic polymer. The conductive polymer may be in an amount ranging from 10 wt % to 20 wt % based on 100 wt % of the light-transmittable conductive polymeric layer 33, preferably, 15 wt % to 20 wt % based on 100 wt % of the light-transmittable conductive polymeric layer 33. The conductive polymer may be a polymer mixture of poly(3,4-ethylenedioxythiophene):poly(styrene-sulfonate) (PEDOT:PSS). The light-transmittable thermoplastic polymer may be selected from one of polyethylene (PE) and polyurethane (PU). Alternatively, the light-transmittable conductive polymeric layer 33 may further include conductive carbon materials, such as carbon nanotubes or graphene.

The electroluminescent layer 34 is formed on the light-transmittable conductive polymeric layer 33, and emits fluorescence upon receiving electrical power. In one embodiment, the electroluminescent layer 34 may include a light-emitting layer 341 that is formed on the light-transmittable conductive polymeric layer 33 and that is made from a mixture of a matrix and an electroluminescent material dispersed in and adhered to the matrix, and a dielectric layer 342 that is formed on the light-emitting layer 341 and that is made from a mixture of a dielectric powder material and an insulating resin.

Additionally, in this embodiment, after transferring the electroluminescent transferable unit 3 of the embodiment to the target object 100, the dielectric layer 342 would be disposed under the light-emitting layer 341. Hence, the dielectric layer 342 would not be required to be light-transmittable, but may be light-transmittable or opaque.

It should be noted that the light-emitting layer 341 and the dielectric layer 342 of the electroluminescent layer 34 may be selected from the materials commonly used for electroluminescent devices. For example, the light-emitting layer 34 may be made from an electroluminescent material selected from the group consisting of ZnS, SrS doped with Ce (SrS:Ce), CaS doped with Eu (CaS:Eu), perovskite, and combinations thereof, dependent upon the required color of the emitted light. The dielectric layer 342 may be made from a powdered dielectric material selected from BaCo₃, BaTiO₃, SrTiO₃, Li₂TiO₃, and so on. The matrix of the light-emitting layer 341 and the insulating resin of the dielectric layer 342 may be made from an electrical insulating and heat resistant polymeric material that is selected from epoxy resin, polyurethane, acrylic resin, and so on. Additionally, the matrix and the insulating resin may be made from an identical material or from different materials.

Alternatively, instead of formation of the light-emitting layer 341 between the dielectric layer 342 and the light-transmittable conductive polymeric layer 33, the dielectric layer 342 may be formed between the light-emitting layer 341 and the light-transmittable conductive polymeric layer 33. The light-transmittable property of the dielectric layer 342 should be considered based on the structural arrangement of the electroluminescent transfer laminate when used in actual practice.

The second electrode-forming layer 35 includes a main portion 352 that is formed on the electroluminescent layer 34, and a second electrode 351 that protrudes from the main portion 352 outwardly of the first protecting layer 31 and that is spaced apart from the first electrode 321. The second electrode-forming layer 35 is made from a conductive material, such as silver, so as to have relatively good electrical conductivity.

The second protecting layer 36 is formed on the second electrode-forming layer 35 and made from a polymeric material, and covers the first electrode 321 of the first electrode-forming layer 32 and the second electrode 351 of the second electrode-forming layer 35. More specifically, the second protecting layer 36 is selected from a polymeric material with solvent resistance, such as epoxy resin, acrylic resin, silicone, and so on. Therefore, the second protecting layer 36 can be used for protecting the electroluminescent transfer unit 3 and other layered structures from being damaged by solvents, such as water and ethylene glycol monobutyl ether (BCS) used during the transfer process.

The adhesive layer 37 is formed on the second protecting layer 36 and adapted to be adhered to the surface 101 of the target object 100. A composition of the adhesive layer 37 is adjustable based on the surface 101 of the target object 100. In one embodiment, the adhesive layer 37 may be selected from an acrylic adhesive, a polyurethane adhesive, or a polyvinyl ester adhesive. Since the adhesive layer 37 per se is not the essential feature of the disclosure and is well-known to those skilled in the art, further details thereof are not provided herein for the sake of brevity.

More specifically, the electroluminescent transfer laminate may further include a release paper (not shown) disposed on the adhesive layer 37, so as to isolate the adhesive layer from the outside environment.

The embodiment of the electroluminescent transfer laminate is manufactured by sequentially forming the constituent layers of the electroluminescent transferable unit 3 on the water-soluble layer 22 of the flexible substrate unit 2 using the screen printing techniques. Each of the first and second protecting layers 31, 36, the light-transmittable conductive polymeric layer 33, the electroluminescent layer 34, and the first and second electrode-forming layers 32, 35 is adjusted to have a thickness not greater than 10 μm, and the electroluminescent transferable unit 3 is adjusted to have a total thickness not greater than 50 μm, and preferably, not greater than 30 μm, so as to improve smoothness of an electroluminescent transfer unit 3′ adhered to the surface 101 of the target object 100.

Before the electroluminescent transfer laminate is transferred to the surface 101 of the target object 100, the electroluminescent transfer laminate is first immersed into a solution of water and ethylene glycol monobutyl ether (BCS) in a ratio ranging from 1:8 to 1:20 so as to activate the adhesive layer 37 and swell the water-soluble layer 22. The adhesive layer 37 is then adhered to the surface 101 of the target object 100. The attachment of the adhesive layer 37 to the surface 101 can be enhanced by scraping a surface of the substrate 21 of the flexible substrate unit 2 that faces away from the surface 101 so that excess solution can be removed simultaneously. Thereafter, the substrate 21 is removed so as to form the electroluminescent transfer unit 3′ on the surface 101 of the target object 100. It should be noted that if the release paper is disposed on the adhesive layer 37, the release paper has to be removed prior to immersion of the electroluminescent transfer laminate in the solution.

The electroluminescent transfer unit 3′ obtained from the embodiment of the electroluminescent transfer laminate has a layered structure, starting from the surface 101 of the target object 100, in the order of the adhesive layer 37, the second protecting layer 36, the second electrode-forming layer 35, the dielectric layer 342, the light-emitting layer 341, the light-transmittable conductive polymeric layer 33, the first electrode-forming layer 32 and the first protecting layer 31. When the first and second electrodes 321, 351 are electrically connected to the power supply (not shown), the electroluminescent transfer unit 3′ is able to exhibit a luminescent pattern.

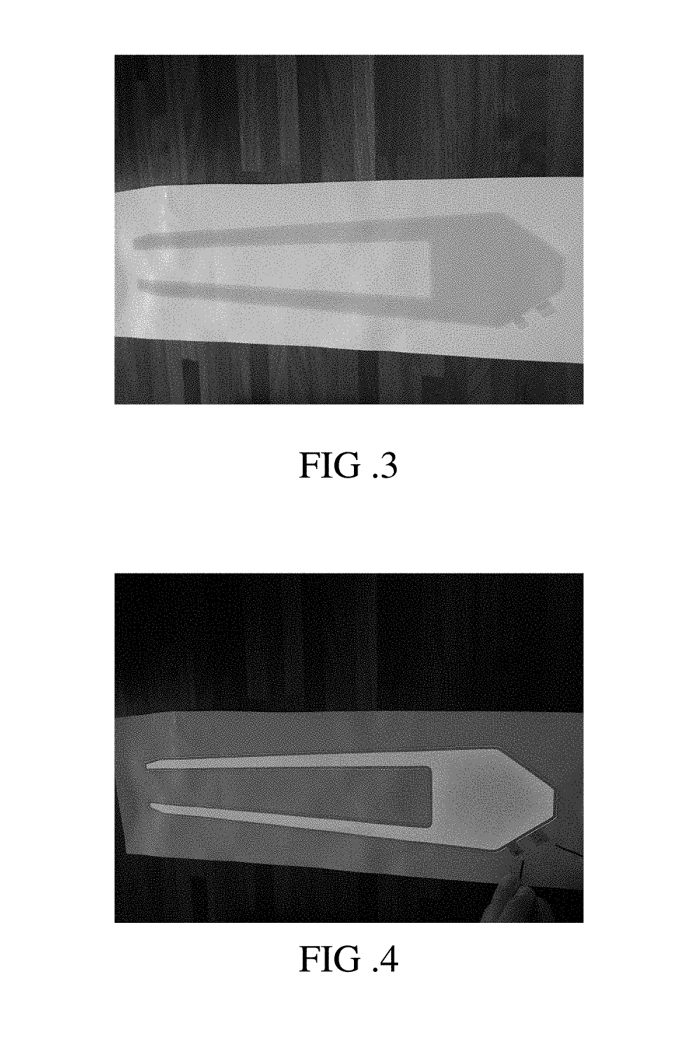

Referring to FIGS. 3 and 4, FIG. 3 is a photograph showing the electroluminescent transfer unit 3′ transferred to the target object 100 in an electrically disconnected state, and FIG. 4 is a photograph showing the electroluminescent transfer unit 3′ transferred to the target object 100 in an electrically connected state to exhibit the luminescent pattern.

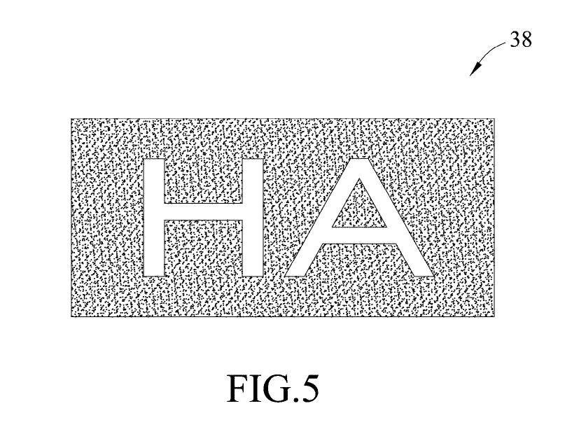

Further referring to FIG. 5, the electroluminescent transfer laminate may further include a light shielding pattern layer 38 formed between the first protecting layer 31 and the water-soluble layer 22 of the flexible substrate unit 2. After the electroluminescent transfer unit 3′ is formed on the target object 100, the light shielding pattern layer 38 may block a part of light passing through the electroluminescent transfer unit 3′ so that the electroluminescent transfer unit 3′ may exhibit various appearances. For instance, when the light shielding pattern layer 38 has a hollow area in the shape of the letters “HA,” the electroluminescent transfer unit 3′ may exhibit the luminescent pattern of the letters “HA” consistent with the hollow area of the light shielding pattern layer 38.

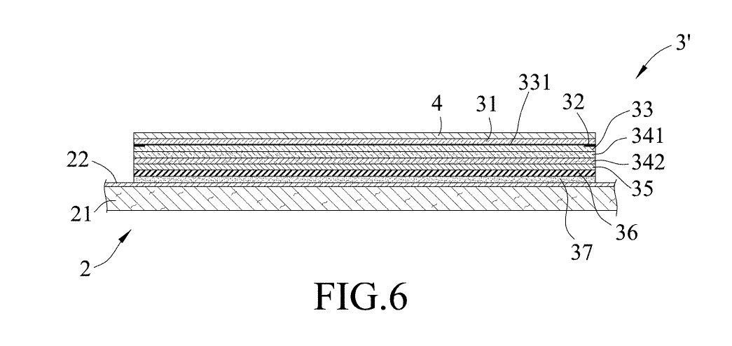

Referring to FIG. 6, the electroluminescent transfer laminate may alternatively have the adhesive layer 37 formed on the water-soluble layer 22 and may further include a flexible supporting film 4 formed on the first protecting layer 31. In this configuration, the layered structure of the electroluminescent transfer laminate starting from the substrate 21 is in the order of the substrate 21, the water-soluble layer 22, the adhesive layer 37, the second protecting layer 36, the second electrode-forming layer 35, the dielectric layer 342, the light-emitting layer 341, the light-transmittable conductive polymeric layer 33, the first electrode-forming layer 32, the first protecting layer 31, and the flexible supporting film 4.

In this embodiment, the flexible supporting film 4 is a light-transmittable polymeric thin film and will be removed after the electroluminescent transfer unit 3′ is formed on the target object 100.

Before the alternative form of the electroluminescent transfer laminate is applied to the surface 101 of the target object 100, the electroluminescent transfer laminate is first dipped in an aqueous solution to resolve the water-soluble layer 22 so as to separate the electroluminescent transferable unit 3 from the substrate 21. The adhesive layer 37 is then adhered to the surface 101 of the target object 100, followed by scraping the flexible supporting film 4 to remove the excess aqueous solution and to enhance the adhesion of the adhesive layer 37 to the surface 101. Lastly, the flexible supporting film 4 is removed from the first protecting layer 31 to form the electroluminescent transfer unit 3′ on the target object 100. Thereafter, the electroluminescent transfer unit 3′ emits light through the electrical connection of the first and second electrodes 321, 351 with an external electric power source.

The second embodiment may further include the light shielding pattern layer 38 that is formed between the first protecting layer 31 and the flexible supporting film 4.

More specifically, the alternative form of the electroluminescent transfer laminate may serve as a heat resistance membrane transfer (HRMT) decal or heat resistance solution transfer (HRST) decal in the field.

In summary, by virtue of the structural arrangement of the electroluminescent transfer laminate of the disclosure, the electroluminescent transfer unit 3′ formed on the surface 101 of the target object 100 is flexible and thin to conform with the profile of the surface 101 of the target object 100 and is able to exhibit various luminescent patterns that are weather resistant and suitable for night-time warnings and that have a controllable illumination time.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An electroluminescent transfer laminate, comprising:
a flexible substrate unit including a water-soluble layer; and
an electroluminescent transferable unit formed on said water-soluble layer, including:
a first protecting layer that is light-transmittable;
a first electrode-forming layer including a conductive looped frame portion that is formed on said first protecting layer, and a first electrode that protrudes from said conductive looped frame portion outwardly of said first protecting layer;
a light-transmittable conductive polymeric layer formed on said conductive looped frame portion and a portion of said first protecting layer exposed from said conductive looped frame portion;
an electroluminescent layer formed on said light-transmittable conductive polymeric layer;
a second electrode-forming layer including a main portion that is formed on said electroluminescent layer, and a second electrode that protrudes from said main portion outwardly of said first protecting layer and that is separated from said first electrode;
a second protecting layer formed on said second electrode-forming layer; and
an adhesive layer formed on said second protecting layer and adapted to be adhered to a surface of a target object.

2. The electroluminescent transfer laminate of claim 1, wherein said first protecting layer is formed on said water-soluble layer.

3. The electroluminescent transfer laminate of claim 2, wherein said light-transmittable conductive polymeric layer includes a conductive polymer and a light-transmittable thermoplastic polymer, said conductive polymer being in an amount ranging from 10 wt % to 20 wt % based on 100 wt % of said light-transmittable conductive polymeric layer.

4. The electroluminescent transfer laminate of claim 3, wherein said conductive polymer is a polymer mixture of poly(3,4-ethylenedioxythiophene):poly(styrenesulfonate)(PEDOT:PSS), said light-transmittable thermoplastic polymer being selected from one of polyethylene (PE) and polyurethane (PU).

5. The electroluminescent transfer laminate of claim 1, wherein said electroluminescent layer (34) includes a light-emitting layer formed on said light-transmittable conductive polymeric layer and a dielectric layer formed on said light-emitting layer, said light-emitting layer being made from a mixture of an electroluminescent material and an insulating resin, said dielectric layer being made from a mixture of a dielectric powder material and an insulating resin.

6. The electroluminescent transfer laminate of claim 1, wherein said second protecting layer covers said first electrode of said first electrode-forming layer and said second electrode of said second electrode-forming.

7. The electroluminescent transfer laminate of claim 1, wherein said electroluminescent transferable unit has a thickness not greater than 50 μm.

8. The electroluminescent transfer laminate of claim 1, further comprising a light shielding pattern layer formed between said first protecting layer and said water-soluble layer of said flexible substrate unit.

9. The electroluminescent transfer laminate of claim 1, wherein said adhesive layer is formed on said water-soluble layer.

10. The electroluminescent transfer laminate of claim 9, further comprising a flexible supporting film formed on said first protecting layer.

11. The electroluminescent transfer laminate of claim 9, wherein said light-transmittable conductive polymeric layer includes a conductive polymer and a light-transmittable thermoplastic polymer, said conductive polymer being in an amount ranging from 10 wt % to 20 wt % based on 100 wt % of said light-transmittable conductive polymeric layer.

12. The electroluminescent transfer laminate of claim 11, wherein said conductive polymer is a polymer mixture of poly(3,4-ethylenedioxythiophene):poly(styrenesulfonate) (PEDOT:PSS), said light-transmittable thermoplastic polymer being selected from one of polyethylene (PE) and polyurethane (PU).

13. The electroluminescent transfer laminate of claim 10, further comprising a light shielding pattern layer formed between said first protecting layer and said flexible supporting film.

14. An electroluminescent transfer unit, which is formed from said electroluminescent transfer laminate as claimed in claim 1 through solvent transfer techniques on the target object, said electroluminescent transfer unit comprising said first protecting layer, said first electrode-forming layer, said light-transmittable conductive polymeric layer, said electroluminescent layer, said second electrode-forming layer, said second protecting layer, and said adhesive layer of said electroluminescent transferable unit of claim 1.
